(19) United States
(12) Patent Application Publication
(10) Pub. No.: US 2018/0039977 A1
(43) Pub. Date: Feb. 8, 2018

(54) SYSTEM AND METHOD FOR CONTROLLING SETTLEMENT

(71) Applicant: MasterCard Asia/Pacific Pte. Ltd., Singapore (SG)

(72) Inventor: Kelvin Lee Chor Hwee, Singapore (SG)

(21) Appl. No.: 15/662,361

(22) Filed: Jul. 28, 2017

(30) Foreign Application Priority Data
Aug. 4, 2016 (SG) 10201606469Q

(51) Int. Cl. G06Q 20/32; G06Q 20/42; G06Q 20/04; G06Q 20/20; G06Q 20/36

(52) U.S. Cl. CPC G06Q 20/3276; G06Q 20/202; G06Q 20/36; G06Q 20/0453; G06Q 20/42

(57) ABSTRACT

In a first aspect, a method is provided for controlling settlement, including receiving, at a merchant register, a settlement request for payment for at least one item and sending a transaction note from the merchant register to a transaction management server and to a mobile device of a user, the transaction note including: an identifier for each item; a transaction note value required to be settled; and a unique identifier. The method further includes receiving, at the mobile device, a confirmation confirming the transaction note is to be settled using a payment vehicle associated with the user; sending the confirmation and the unique identifier to a settlement server for affecting settlement of the transaction note value; upon successful settlement: sending a settlement confirmation from the settlement server to the transaction management server; updating the merchant register to reflect settlement of the transaction note; and producing a receipt confirming settlement.

### TECHNICAL FIELD

The present invention relates to a method for controlling settlement, and a system for performing that method.

### BACKGROUND

Businesses are increasingly dealing with upward movement of labour costs and increased competition. Labour costs often constitute a large proportion of the operating expenses of a business. For some businesses, in order to stay profitable the labour component of operating expenses should be minimized. One way to achieve this is by reducing staff numbers. However, reducing staff numbers often results in increased customer service time, consequent decreased customer satisfaction and decreased customer retention.

Particularly in the food and beverage industry, profitability often relates to turnaround time—the time taken to serve a table, have the customer pay for that service and depart so that table can be cleaned and a new customer can use it. A customer who has finished consuming their food and beverage is not going to deliver any additional revenue for the business. However, that customer can occupy a table until they are attended to for making payment, and can thus deprive the business of the use of that table until the bill is presented and paid.

Often times, to make payment for a bill the customer will provide their credit or debit card and a staff member will take that card to process payment. The card is then return with a payment voucher for signing by the customer. For the period of time from accepting the card to returning it with the payment voucher, the staff member has access to the card details. This represents a breakdown in security since the card details will be available to at least one party who is not the cardholder.

It is desirable that there be provided a method for affecting settlement of transactions that reduces settlement time or reduces the opportunity for theft of card details.

### SUMMARY

The present disclosure provides a method for controlling settlement, comprising:
receiving, at a merchant register, a settlement request for payment for at least one item;
sending a transaction note from the merchant register to a transaction management server and to a mobile device of a user, the transaction note comprising:
   an identifier for each item;
   a transaction note value required to be settled; and
   a unique identifier;
receiving, at the mobile device, a confirmation confirming the transaction note is to be settled using a payment vehicle associated with the user;
sending the confirmation and the unique identifier to a settlement server for affecting settlement of the transaction note value;
upon successful settlement:
   sending a settlement confirmation from the settlement server to the transaction management server; and
   updating the merchant register to reflect settlement of the transaction note; and
   producing a receipt confirming settlement, for provision to the user

The present disclosure further provides a system for controlling settlement, comprising:
a settlement server comprising:
   at least one settlement server processor; and
   at least one settlement server memory including settlement server computer program code;
a merchant register for receiving a settlement request for payment for at least one item; and
a transaction management server comprising:
   at least one transaction server processor; and
   at least one transaction server memory including transaction server computer program code,
the at least one transaction server memory and the transaction server computer program code configured to, with the at least one transaction server processor, cause the transaction management server at least to:
   receive a transaction note from the merchant register, and send the transaction note to a mobile device of a user, the transaction note comprising:
      an identifier for each item;
      a transaction note value required to be settled; and
      a unique identifier;
the at least one settlement server memory and the settlement server computer program code configured to, with the at least one settlement processor, cause the settlement server at least to:
   receive, from the mobile device, a confirmation confirming the transaction note is to be settled using a payment vehicle associated with the user; and
   receive, from one of the mobile device and transaction management server, the unique identifier for affecting settlement of the transaction note value;
wherein the merchant register is configured to be updated to reflect successful settlement of the transaction note upon receipt of confirmation from the settlement server, via the transaction management server, that settlement has been successful; and
wherein one of the merchant register and transaction management server is configured to produce a receipt confirming settlement, for provision to the user.

### BRIEF DESCRIPTION OF THE DRAWINGS

Some embodiments will now be described by way of non-limiting example only, with reference to the accompanying drawings in which:

FIG. 1 illustrates a method for controlling settlement in accordance with present teachings;

FIG. 2 is a schematic overview of a system and process for initiating settlement;

FIG. 3 is a schematic overview of a system a process for affecting settlement;

FIG. 4 is an overview of a network for affecting settlement, over which is superimposed a method for using that network;

FIG. 5 shows a schematic of a system or network for controlling settlement according to present teachings; and

FIG. 6 shows an exemplary computing device suitable involved in execution of a method for controlling settlement according to present teachings.

### DETAILED DESCRIPTION

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the invention.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium such as exemplified in the Internet system, or wireless medium such as exemplified in the GSM mobile telephone system. The computer program when loaded and executed on such a computer effectively results in an apparatus that implements the steps of the preferred method.

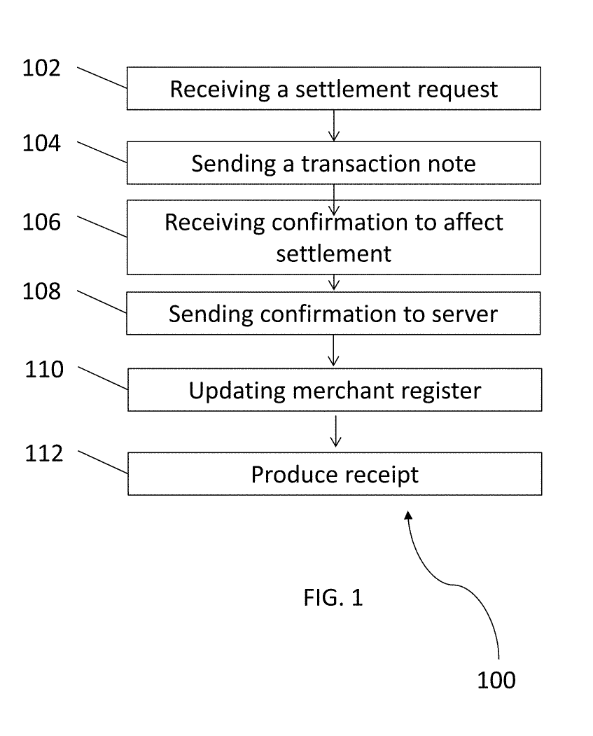

FIG. 1 illustrates a method 100 for controlling settlement. The method 100 broadly comprises the steps of:

Step 102: receiving a settlement request;

Step 104: sending a transaction note;

Step 106: receiving confirmation to affect settlement;

Step 108: sending confirmation to settlement server;

Step 110: updating merchant register; and

Step 112: produce receipt.

Settlement is the process of transferring funds from a first party to a second party, to pay for goods and/or services rendered by the second party. While examples given hereafter may relate specifically to the supply of goods or services separately, or of particular goods or particular services, it will be understood that the same concepts are considered applicable to settling payment or goods and services more generally and all such settlement transactions are intended to fall within the scope of the present disclosure.

Step 102 involves receiving a request for settlement of a transaction. When considering the food and beverage industry, a settlement request in a restaurant is tantamount to requesting the bill (transaction note). That request can be made on a user's smartphone, or other portable electronic device, or at a register such as a Micros® terminal.

Where the request is made using a smartphone the user may perform any one of a number of actions. In one embodiment, an identifier such as a quick response (QR) code is provided at the table. The user opens an app for scanning the identifier, scans the identifier and retrieves or receives a transaction note (step 104). The app may comprise a standard QR-code or identifier scanning app or may comprise a digital wallet app that provides the relevant scanning functionality. In another embodiment, a near-field communications (NFC) reader is provided at the table such that a NFC-enabled smartphone or other device can perform a handshake during which the transaction note is pushed to the smartphone or other device.

The user may alternatively use their smartphone or other device to log onto a webpage such as the webpage of a merchant who has rendered the services or supplied the goods. Then entering the table number or other unique identifier may result in the invoice being produced on the screen of the smartphone or other device.

The above processes initiate the request for settlement. After initiation the request is passed from the smartphone or other device to a merchant register at which it is received. The merchant register is in communication with a Micros® interface so that goods and services (items) entered into that interface for consumption by the user are recorded in the register. The request comprises the relevant unique identifier so the merchant register can match the request with at least one item (i.e. a good or a service) for which settlement is desired to be made. In the context of a restaurant bill, the item or items will typically comprise the food and/or beverages the user has consumed.

The initiated request may be sent through various pathways. The request may be sent directly from the smartphone or other device to the merchant register. The request may alternatively be sent from the smartphone to a transaction management server (e.g. a cloud server such as Fidelio®) that manages transaction communications for the merchant. The transaction management server then requests the transaction note from the merchant register. In a further embodiment, the smartphone or other device sends the request via a beacon or relay (with which it is paired) to the merchant register. The request may alternatively pass from the beacon to the transaction management server that then requests the transaction note from the merchant register. The smartphone or other device may automatically pair with the beacon or relay so that user need not perform any complicated pairing processes. Moreover, the beacon or relay may have a limited field so that it cannot be paired with smartphone or other devices outside the merchant's premises. In a further embodiment, since the smartphone or other device may initiate the request by scanning the unique identifier in a digital wallet app, the digital wallet app may communicate the unique identifier to a settlement server—in this case, the unique identifier may include a merchant code as well as an identifier by which the relevant goods and/or services can be identified. The settlement server (e.g. a cloud server such as MasterCard Payment Gateway Services®) then forwards the request to the relevant transaction management server—noting there may be one such transaction management server associated with one or more merchants and a different such server associated with one or more other merchants—that again forwards the request to the merchant register.

Upon receipt of the settlement request at the merchant register, regardless of the route taken by the request to arrive at the server, the merchant register identifies or produces a transaction note. The transaction note is, in effect, an invoice or debit note comprising at least:

an identifier for each item;

an transaction note value required to be settled; and

a unique identifier.

The merchant register then sends the transaction note to the transaction management server and to the mobile device of the user (step 104). Where the merchant register comprises part of a Micros® terminal, the transaction note may be sent from that terminal directly to the mobile device as a push message, or back through any of the paths along which the settlement request could have been forwarded to the merchant register. For example, where the user's mobile device is paired with a beacon and the settlement request was sent through the beacon to the merchant register, the merchant register may send the transaction note as a push message, via a beacon which may be the same beacon as was used when making the settlement request, to the mobile device of the user. The forward path for the settlement request may differ from the backward path for the transaction note.

The transaction note reaches the user's mobile device and is displayed to the user for confirmation. The user may receive the transaction note is any appropriate format, provided the format yields sufficient information to facilitate review of the transaction note by the user so the user can confirm the transaction note is accurate.

After review, the mobile device receives a confirmation confirming the transaction note is to be settled using a payment vehicle associated with the user (step 106). The payment vehicle may be a credit card or debit card, a bank account or any other instrument associated with funds that can be debited to facilitate settlement of the transaction. Where the user has requested settlement using a digital payment app, or through the merchant webpage, a payment mark may be displayed for selection by the user. The payment mark is associated with a digital wallet that is invoked upon selection of the payment mark, so as to identify a payment vehicle to be used for settlement. Alternatively, where the unique identifier is scanned using functionality provided in the user's digital wallet app, the payment mark may be replaced with a confirmation button.

Selection of the payment mark or confirmation button, or payment mark followed by confirmation button where selection of the payment mark opens the digital wallet app for subsequent selection of a payment vehicle, result in production of a confirmation. The confirmation confirms payment is to be made using the relevant payment vehicle associated with the user.

To affect settlement, the mobile device sends the confirmation and the unique identifier to the settlement server for affecting settlement of the transaction note value (step 108). The mobile device may also send the transaction value to the settlement server. Alternatively, the settlement server may receive the transaction value form the transaction management server. The settlement server processes payment in accordance with any settlement process. For example, the settlement server may employ the common process of sending the unique identifier and transaction value to the acquirer bank of the relevant payment vehicle. The acquirer bank then forwards the identifier and transaction value to the issuer bank (if different from the acquirer bank). If there are sufficient funds associated with the payment vehicle then the transaction value is debited from those funds and is sent to the acquirer bank minus any applicable issuer bank fee, with the unique identifier. If there are insufficient funds associated with the payment vehicle then a transaction declination message is sent to the acquirer bank with the unique identifier. The unique identifier, along with the funds (for ease, “funds” will be taken to mean ‘funds minus any applicable fee or fees’ as context requires) or declination message, is sent to the settlement server that forwards confirmation of settlement or declination to the mobile device.

Upon successful settlement, the merchant register is updated to reflect settlement of the transaction note (step 110). This may involve the settlement confirmation being sent from the settlement server to the transaction management server, and the transaction management server sending settlement confirmation to the merchant register so the merchant register can be updated.

After confirmation of settlement, the user is required to be provided or offered a receipt of settlement or purchase (step 112). The receipt confirming settlement can be produced, for provision to the user, by printing at a terminal (e.g. Micros® terminal) and providing the printed copy to the user. Alternatively, the transaction management server may send the invoice (e.g. as a push message) to the mobile device. The production of the receipt can be automatic such that the push message is automatically sent to the mobile device once the transaction management server receives the confirmation of settlement. The receipt may alternatively be sent to the mobile device upon confirmation by the merchant that it has received settlement or confirmation of settlement from the transaction management server.

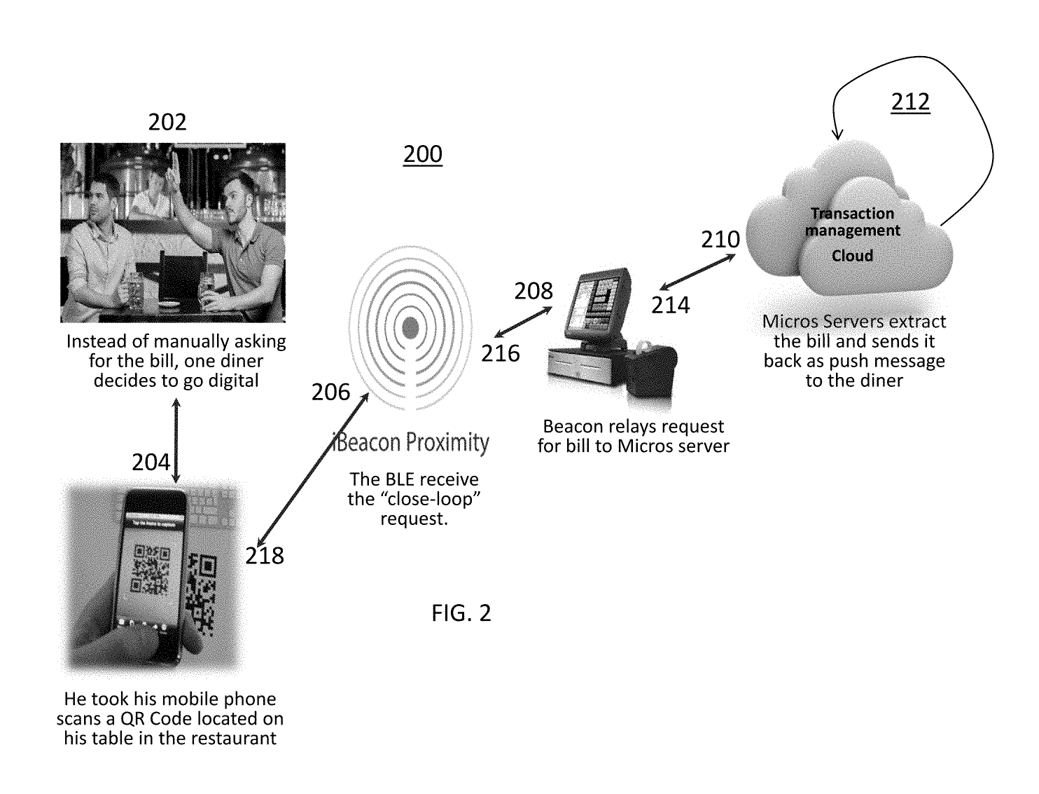

FIG. 2 illustrates a process and method 200 for steps 102 and 104 of FIG. 1. Initially, a consumer or user makes a settlement request (step 202). As mentioned above, this could involve the user requesting a copy of the invoice from a waiter. The invoice may comprise a scannable unique identifier in the same way as the table at which the user is sitting may comprise a scannable unique identifier (e.g. on a stand on the table). In the case the invoice comprises a scannable unique identifier, instead of the user providing their credit card, debit card or cash to the waiter, they could instead perform the remainder of the settlement process using a mobile device such as their smartphone.

In either case, the user scans the unique identifier (step 204). This scanning process is performed using a digital wallet app on the mobile device.

The mobile device automatically pairs with a Bluetooth low energy beacon (step 206) associated with the merchant who has supplied the goods or services the payment for which the user is currently intending to settle. This pairing connection is a wireless connection. It will be understood that a variety of wireless devices may be used in place of Bluetooth low energy (BLE) beacons.

The BLE beacon relays the request to the merchant register (step 208). The merchant register in the present embodiment is hosted on a server, which is presently the transaction management server. Thus the request for settlement is sent to the server (step 210).

The server extracts the transaction note (step 212). This extraction process involves compiling the relevant information, such as an identifier of each article, the transaction value and unique identifier. The identifier of each article may be a description of that article—for example “beef pie” where the user has consumer a beef pie—or a product code. The transaction value may comprise a single total value for the basket, a separate value for each article, or both. The unique identifier for the transaction note may simply be the invoice number. That identifier may alternatively comprise an invoice number along with other information such as a merchant identifier. This will enable the merchant to be identifier in case other parties are using comparable invoice numbers. Thus the unique identifier is intended to be unique for transaction notes issued by merchants that use a particular transaction management server. The identifier may also be unique for all merchants using any such server, or to be unique for all transaction occurring over a particular period of time. To that end, the unique identifier may also comprise a date and time.

A discount, offer or other value-added service may also be applied to or accrued on the transaction note. If applicable at the time the settlement request is made, the transaction note may comprise value-added-service information identifying the nature of the value-added service—for example “6% discount for using your MasterCard”.

Once the transaction note has been extracted it is sent back to the mobile device for approval. This sending process can involve sending the transaction note in any one of a number of formats. For example, the transaction note may be sent in one of:
static format, meaning the transaction note is sent as a static, unchangeable file for display to the user;
flat format, meaning the transaction note is formattable but not editable; or
point-to-point format, meaning the transaction note is formattable and editable.

In the embodiment shown in FIG. 2, the return path of the transaction note is a mirror image of the forward path. In other words, the transaction note is sent from the merchant register (presently via the terminal—step 214) to the beacon (step 216), and from the beacon to the mobile device paired with the beacon (step 218). The message is sent as a push notification to the mobile device and the contents of that notification are then displayed to the user.

Other push notifications can similarly be sent. For example, the mobile device may automatically pair with a beacon upon the user entering the merchant's premises. The mobile device may receive push notifications advising them of deals or offers available at those premises. A push notification may also be sent when the user is using their digital wallet app. For example, when the user opens their digital wallet app to scan the unique identifier, the wallet app may request for information on deals available to the user. These deals may be linked to one or more particular payment vehicles in the digital wallet app. The request for information may be sent via the beacon to the merchant register that then sends the relevant deals or offers as a push notification back to the mobile device via the beacon. Alternatively, the digital wallet app may connect to a server such as that of a value-added-services provider, from which it requests information on available deals or offers. The value-added-services provider will then send a notification back to the digital wallet app that displays the available value-added-services to the user on the mobile device.

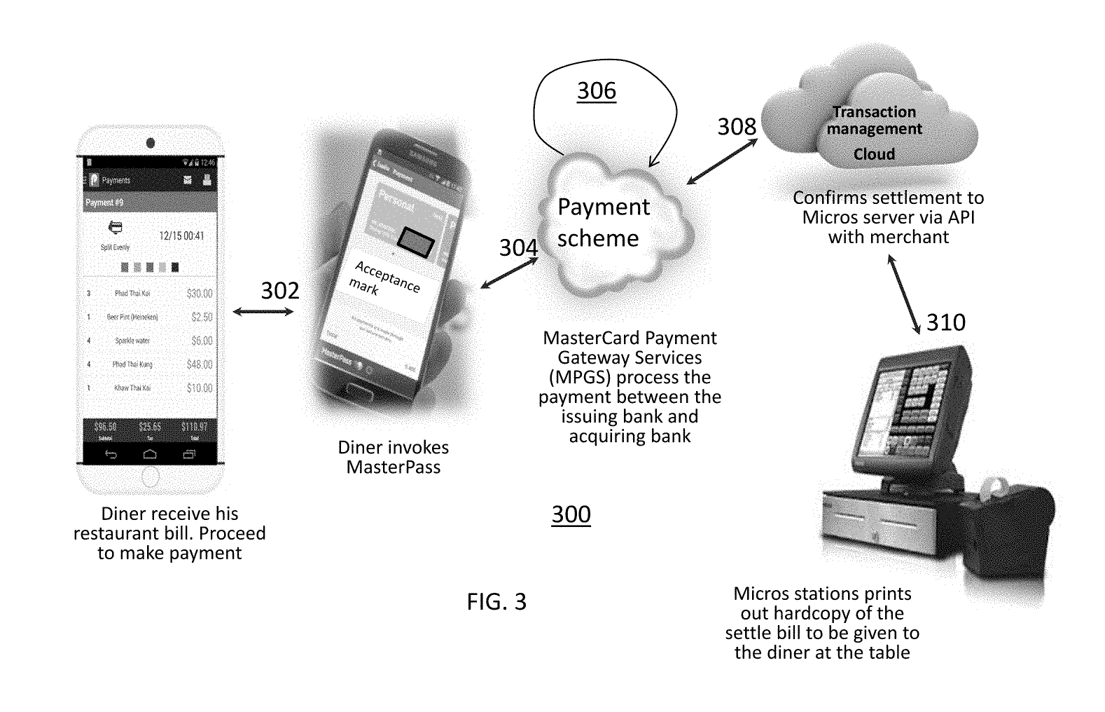

FIG. 3 illustrates a process or method 300 for performing steps 106 to 112 of FIG. 1. The process or method 300 commences upon receipt of the transaction note at the mobile device. If the user considers the transaction note to be in order for payment, the mobile device receives a confirmation to affect settlement. That confirmation comprises invoking a digital wallet app, or selecting a confirmation button in the digital wallet app if the digital wallet app has been used to extract the transaction note (e.g. by providing functionality enabling the unique identifier to be scanned)—step 302.

The digital wallet app enables selection of the payment vehicle with which payment is to be made. Upon selection of a payment vehicle the details of the payment vehicle and transaction details (e.g. unique identifier (which may include a merchant identifier (ID) that identifies the merchant and a receipt number, and a transaction value)) are sent to the settlement server—step 304. The settlement server performs settlement in a known manner that need not be described further herein—step 306.

Upon successful settlement the settlement server sends a settlement confirmation to the transaction management server that manages transaction between the merchant and third parties, on behalf of the merchant—step 308. The transaction management server then updates the merchant register—step 310. Updating the merchant register in the present instance comprises updating a merchant terminal to reflect settlement of the transaction note. For example, when settlement is being made of a restaurant bill (transaction note) the Micros® terminal will be updated to reflect payment has been made so the restaurateur will not prevent the customer (user) from leaving the restaurant.

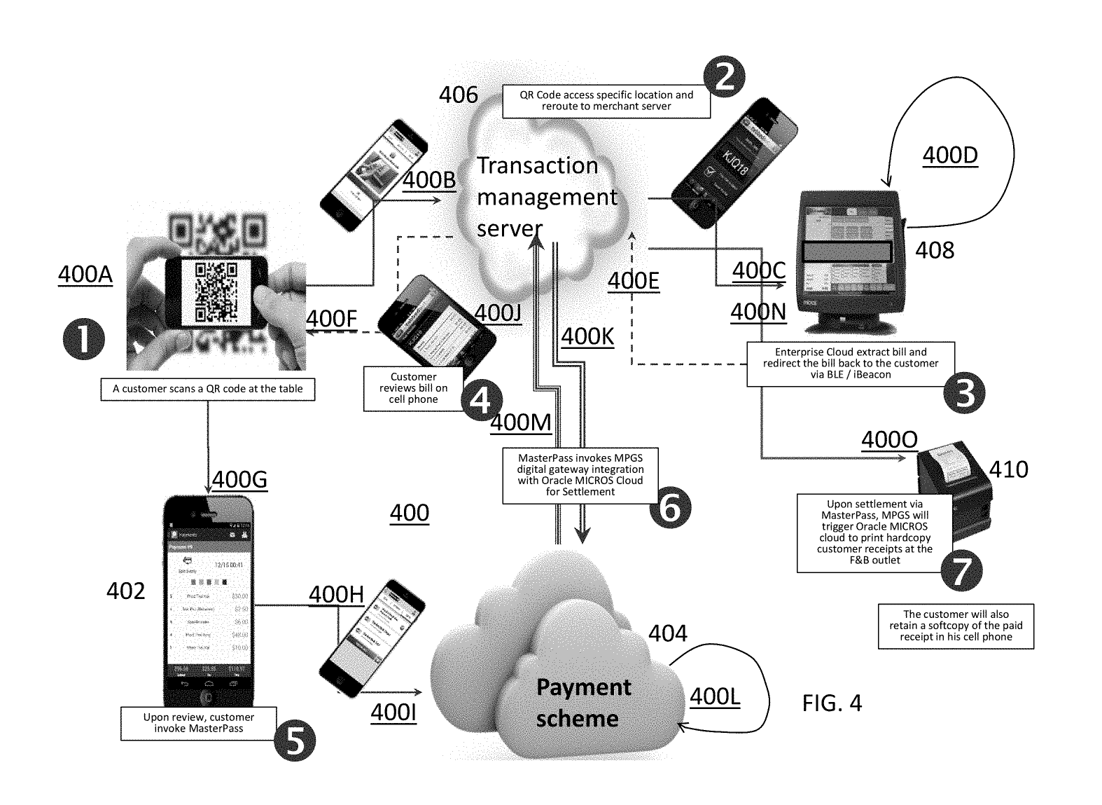

FIG. 4 provides a schematic overview of a network 400 for controlling settlement, with process steps superimposed over that network 400. The network 400 comprises:
a user terminal or mobile device 402;
a settlement server 404;
a transaction management server 406;
a merchant register 408; and
a merchant terminal 410. In some embodiments, the merchant register 408 comprises part of the transaction management server 406. In other embodiments, the merchant register 408 comprises part of the merchant terminal 410. In further embodiments, the content of the merchant register (e.g. invoice number, article descriptions, prices, value-added-services, merchant ID) are distributed across, or duplicated in, both the transaction management server 406 and merchant terminal 410.

While the network of FIG. 4 can operate to transmit settlement requests, affect settlement and transmit confirmations using any desired method including those previously described, a single implementation of the network to achieve settlement will be provided herein with reference to FIG. 4.

To initiate the method, the user scans a QR-code—step 400A. The scanning process is achieved using the user's smartphone. The scanning functionality may be provided by an app on the smartphone, such as a digital wallet app. Upon scanning the QR-code a settlement request is sent from the smartphone to the transaction management server 406—step 400B.

The transaction management server 406 forwards the settlement request to the merchant register 408—step 400C, at which the transaction note is compiled or extracted 400D. The transaction note is then sent back to the transaction management server 406—step 400E—and from the transaction management server 406 to the smartphone—step 400F. The transaction note becomes a push notification that is presented to the user—step 400G.

The user can then review the transaction note or approve or decline it for settlement. The declination may result in a declination being sent to the merchant register or merchant terminal (via any intervening components such as the transaction management server or a beacon). This may prompt a staff member to approach the user to find out why the transaction note was not deemed suitable for settlement.

Upon approving of the transaction note, the user will confirm settlement should be made. That confirmation may comprise selecting a confirmation button where a digital wallet app was used for the original scanning process, or where the push notification automatically invokes a user's digital wallet. The confirmation may alternatively comprise invoking the digital wallet by selecting a digital wallet payment mark (not shown but well understood by the skilled person)—step 400H. This opens the digital wallet for selection of a payment vehicle with which to affect settlement of the transaction note. Selection of a payment vehicle results in the transaction note, or a subset of the details thereof as necessary for settlement, being sent to the settlement server 404—step 400I. Where the smartphone 402 does not send sufficient information to facilitate settlement, the settlement server 404 may communicate with the transaction management server 406 to obtain the necessary details to affect settlement—step 400J. The transaction management server 406 responds by forwarding transaction details to the settlement server 404 that are necessary for affecting settlement—step 400K.

Once all the necessary details are collected, settlement is affected—step 400L. This is achieved using known processes. Upon successful settlement, the confirmation of settlement is forwarded from the settlement server 404 to the transaction management server 406—step 400M. The confirmation comprises, or is accompanied by, the unique ID (which may also refer to a version of the unique ID that serves the same purpose, namely to facilitate recognition of the transaction note for which settlement has been made). The transaction management server 406 sends a confirmation to the merchant register 408—step 400N—to ensure the merchant register reflects the confirmed settlement.

A receipt is then produced, providing evidence to the user that settlement has been confirmed by the merchant—step 400O. Production of the receipt may be initiated at the merchant register 408, the merchant terminal 410 or the transaction management server 406. The receipt may be delivered in various forms, using various delivery methods such as:
physical production of a printed copy for provision to the user; or
preparation of a digital copy for sending to the user as a push notification, email, text message and the like—the digital copy may be forwarded from the transaction management server 406 to the smartphone 402, directly or via a beacon (not shown) or via the settlement server 404.

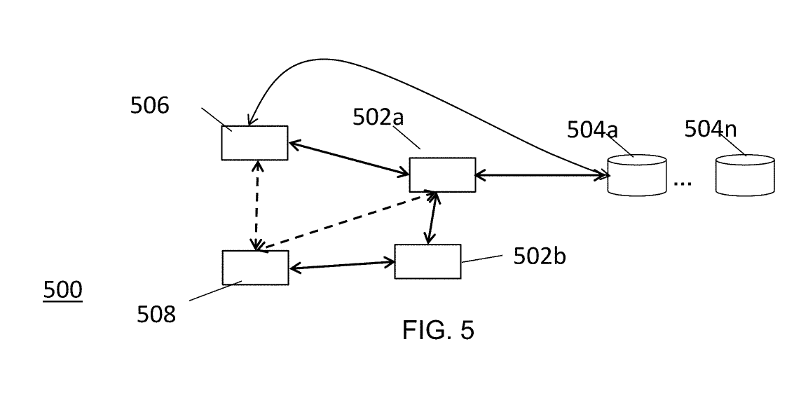

FIG. 5 shows a schematic of a network-based system 500 for controlling settlement according to an embodiment of the invention. The system 500 comprises computers or servers 502a, 502b (each of which may be a cloud server), one or more databases 504a . . . 504n, a user input module 506 (e.g. merchant terminal) and a user output module 508 (e.g. smartphone, which may also constitute a user input terminal for input a settlement request). Each of the one or more databases 504a . . . 504n are communicatively coupled with the computer 502a. The user input module 506 and a user output module 508 may be separate and distinct modules communicatively coupled with the computers 502a, 502b. Alternatively, the user input module 506 and a user output module 508 may be integrated within a single mobile electronic device (e.g. a mobile phone, a tablet computer, Micros® station etc.). The mobile electronic device may have appropriate communication modules for wireless communication with the computer 502 via existing communication protocols.

The computer 502 may comprise: at least one processor; and at least one memory including computer program code; the at least one memory and the computer program code configured to, with at least one processor, cause the computer at least to: (A) receive, at a merchant register, a settlement request for payment for at least one item; (B) send a transaction note from the merchant register to a transaction management server and to a mobile device of a user, the transaction note comprising:
an identifier for each item;
an transaction note value required to be settled; and
a unique identifier;
(C) receive, at the mobile device, a confirmation confirming the transaction note is to be settled using a payment vehicle associated with the user; (D) send the confirmation and the unique identifier to a settlement server for affecting settlement of the transaction note value; (D) upon successful settlement:
send a settlement confirmation from the settlement server to the transaction management server; and
update the merchant register to reflect settlement of the transaction note; and (E) produce a receipt confirming settlement, for provision to the user.

The various types of data, e.g. article descriptors or identifiers, merchant identifiers, article or total transaction values, dates and times of transactions, receipt numbers, settlement or non-settlement flags (indicating whether or not a transaction note has been settled or not settled), value-added-services information and payment vehicle details can be stored on a single database (e.g. 504a), or stored in multiple databases (e.g. payment vehicle details are stored on database 504a, value-added-services information is stored on database 504n, etc.). The databases 504a . . . 504n may be realized using cloud computing storage modules and/or dedicated servers communicatively coupled with the computer 502.

It will be appreciated that other system components may be introduced without detracting from the operation of the network 500. For example, a beacon may be introduced between the output device 508 and the server 502a or between the device 508 and the input device 506, thereby to facilitate transmission of the settlement request and also of the push notice containing the transaction note.

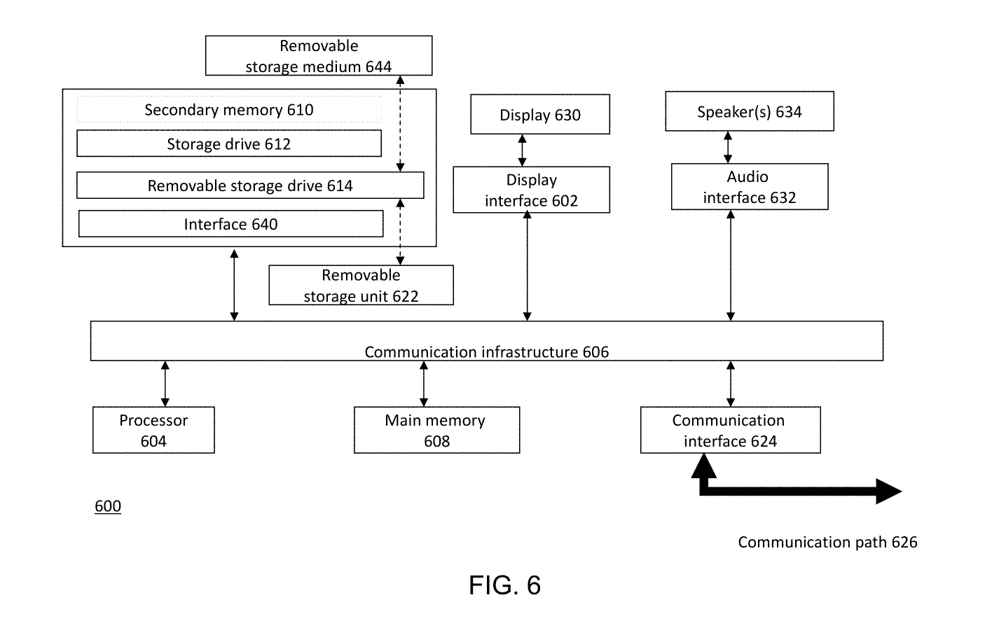

FIG. 6 depicts an exemplary computer/computing device 600, hereinafter interchangeably referred to as a computer system 600, where one or more such computing devices 600 may be used to facilitate execution of the above-described method for controlling settlement. In addition, one or more components of the computer system 600 may be used to realize the computer or server 502. The following description of the computing device 600 is provided by way of example only and is not intended to be limiting.

As shown in FIG. 6, the example computing device 600 includes a processor 604 for executing software routines. Although a single processor is shown for the sake of clarity, the computing device 600 may also include a multi-processor system and be used for cloud computing to facilitate removal of processing infrastructure from individual merchants and users, and instead remotely located that infrastructure in a common cloud server system. The processor 604 is connected to a communication infrastructure 606 for communication with other components of the computing device 600. The communication infrastructure 606 may include, for example, a communications bus, cross-bar, or network.

The computing device 600 further includes a main memory 608, such as a random access memory (RAM), and a secondary memory 610. The secondary memory 610 may include, for example, a storage drive 612, which may be a hard disk drive, a solid state drive or a hybrid drive and/or a removable storage drive 614, which may include a magnetic tape drive, an optical disk drive, a solid state storage drive (such as a USB flash drive, a flash memory device, a solid state drive or a memory card), or the like. The removable storage drive 614 reads from and/or writes to a removable storage medium 644 in a well-known manner. The removable storage medium 644 may include magnetic tape, optical disk, non-volatile memory storage medium, or the like, which is read by and written to by removable storage drive 614. As will be appreciated by persons skilled in the relevant art(s), the removable storage medium 644 includes a computer readable storage medium having stored therein computer executable program code instructions and/or data.

In an alternative implementation, the secondary memory 610 may additionally or alternatively include other similar means for allowing computer programs or other instructions to be loaded into the computing device 600. Such means can include, for example, a removable storage unit 622 and an interface 640. Examples of a removable storage unit 622 and interface 640 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 622 and interfaces 640 which allow software and data to be transferred from the removable storage unit 622 to the computer system 600.

The computing device 600 also includes at least one communication interface 624. The communication interface 624 allows software and data to be transferred between computing device 600 and external devices via a communication path 626. In various embodiments of the inventions, the communication interface 624 permits data to be transferred between the computing device 600 and a data communication network, such as a public data or private data communication network. The communication interface 624 may be used to exchange data between different computing devices 600 which such computing devices 600 form part an interconnected computer network. Examples of a communication interface 624 can include a modem, a network interface (such as an Ethernet card), a communication port (such as a serial, parallel, printer, GPIB, IEEE 1393, RJ35, USB), an antenna with associated circuitry and the like. The communication interface 624 may be wired or may be wireless. Software and data transferred via the communication interface 624 are in the form of signals which can be electronic, electromagnetic, optical or other signals capable of being received by communication interface 624. These signals are provided to the communication interface via the communication path 626.

As shown in FIG. 6, the computing device 600 further includes a display interface 602 which performs operations for rendering images to an associated display 630 and an audio interface 632 for performing operations for playing audio content via associated speaker(s) 634.

As used herein, the term “computer program product” may refer, in part, to removable storage medium 644, removable storage unit 622, a hard disk installed in storage drive 612, or a carrier wave carrying software over communication path 626 (wireless link or cable) to communication interface 624. Computer readable storage media refers to any non-transitory, non-volatile tangible storage medium that provides recorded instructions and/or data to the computing device 600 for execution and/or processing. Examples of such storage media include magnetic tape, CD-ROM, DVD, Blu-ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a SD card and the like, whether or not such devices are internal or external of the computing device 600. Examples of transitory or non-tangible computer readable transmission media that may also participate in the provision of software, application programs, instructions and/or data to the computing device 600 include radio or infra-red transmission channels as well as a network connection to another computer or networked device, and the Internet or Intranets including e-mail transmissions and information recorded on Websites and the like.

The computer programs (also called computer program code) are stored in main memory 608 and/or secondary memory 610. Computer programs can also be received via the communication interface 624. Such computer programs, when executed, enable the computing device 600 to perform one or more features of embodiments discussed herein. In various embodiments, the computer programs, when executed, enable the processor 604 to perform features of the above-described embodiments. Accordingly, such computer programs represent controllers of the computer system 600.

Software may be stored in a computer program product and loaded into the computing device 600 using the removable storage drive 614, the storage drive 612, or the interface 640. Alternatively, the computer program product may be downloaded to the computer system 600 over the communications path 626. The software, when executed by the processor 604, causes the computing device 600 to perform functions of embodiments described herein.

It is to be understood that the embodiment of FIG. 6 is presented merely by way of example. Therefore, in some embodiments one or more features of the computing device 600 may be omitted. Also, in some embodiments, one or more features of the computing device 600 may be combined together. Additionally, in some embodiments, one or more features of the computing device 600 may be split into one or more component parts.

It will be appreciated by a person skilled in the art that numerous variations and/or modifications may be made to the present invention as shown in the specific embodiments without departing from the spirit or scope of the invention as broadly described. The present embodiments are, therefore, to be considered in all respects to be illustrative and not restrictive.

1. A computer-implemented method for controlling settlement, comprising:
receiving, at a merchant register, a settlement request for payment for at least one item;
sending a transaction note from the merchant register to a transaction management server and to a mobile device of a user, the transaction note comprising:
an identifier for each item;
a transaction note value required to be settled; and
a unique identifier;
receiving, at the mobile device, a confirmation confirming the transaction note is to be settled using a payment vehicle associated with the user;
sending the confirmation and the unique identifier to a settlement server for affecting settlement of the transaction note value;
upon successful settlement:
sending a settlement confirmation from the settlement server to the transaction management server; and
updating the merchant register to reflect settlement of the transaction note; and
producing a receipt confirming settlement, for provision to the user.

2. The computer-implemented method of claim 1, further comprising generating the settlement request at the mobile device.

3. The computer-implemented method of claim 2, further comprising reading a unique identifier using the mobile device, wherein the step of receiving, at the merchant register, a settlement request comprises receiving the unique identifier by which the at least one item can be identified.

4. The computer-implemented method of claim 3, wherein the unique identifier comprises a quick-response (QR) code.

5. The computer-implemented method of claim 1, wherein sending the transaction note comprises extracting the identifier for each item and the transaction note value from the merchant register, based on the unique identifier.

6. The computer-implemented method of claim 1, wherein the step of receiving, at the mobile device, the confirmation comprises invocation of a digital wallet on the mobile device.

7. The computer-implemented method of claim 1, further comprising initiating the settlement request using a digital wallet app, wherein the step of receiving, at the mobile device, the confirmation comprises receiving a selection of a button in the digital wallet app to confirm settlement should be made.

8. The computer-implemented method of claim 1, further comprising sending a request, from the settlement server to the transaction management server, to obtain transaction details to effect settlement of the transaction note, the request comprising the unique identifier.

9. The computer-implemented method of claim 8, further comprising sending the transaction details from the transaction management server to the settlement server in response to receipt of the request to obtain transaction details.

10. The computer-implemented method of claim 1, wherein producing the receipt comprises sending an email comprising the receipt to an email address accessible by the user.

11. The computer-implemented method of claim 1, wherein producing the receipt comprises sending a push notification to the mobile device of the user, the push notification comprising the receipt.

12. The computer-implemented method of claim 1, wherein the transaction management server comprises a cloud server in communication with the settlement server and wherein the step of receiving the settlement request comprises receiving the settlement request from the cloud server.

13. The computer-implemented method of claim 1, wherein the transaction management server comprises a cloud server in communication with the settlement server and the step of sending a transaction note from the merchant register to the device of the user comprises sending the transaction note to the cloud server and from the cloud server to the mobile device.

14. The computer-implemented method of claim 1, wherein the settlement server comprises a cloud server in communication with the transaction management server and the step of sending a settlement confirmation from the settlement server to the transaction management server comprises sending the settlement confirmation from the cloud server of the settlement server to a cloud server of the transaction management server.

15. A system for controlling settlement, comprising:
a settlement server comprising:
at least one settlement server processor; and
at least one settlement server memory including settlement server computer program code;
a merchant register for receiving a settlement request for payment for at least one item; and
a transaction management server comprising:
at least one transaction server processor; and
at least one transaction server memory including transaction server computer program code,
the at least one transaction server memory and the transaction server computer program code configured to, with the at least one transaction server processor, cause the transaction management server at least to:
receive a transaction note from the merchant register, and send the transaction note to a mobile device of a user, the transaction note comprising:
an identifier for each item;
a transaction note value required to be settled; and
a unique identifier;
the at least one settlement server memory and the settlement server computer program code configured to, with the at least one settlement processor, cause the settlement server at least to:
receive, from the mobile device, a confirmation confirming the transaction note is to be settled using a payment vehicle associated with the user; and
receive, from one of the mobile device and transaction management server, the unique identifier for affecting settlement of the transaction note value;
wherein the merchant register is configured to be updated to reflect successful settlement of the transaction note upon receipt of confirmation from the settlement server, via the transaction management server, that settlement has been successful; and
wherein one of the merchant register and transaction management server is configured to produce a receipt confirming settlement, for provision to the user.

16. A system according to claim 15, wherein receiving the transaction note comprises extracting the identifier for each item and the transaction note value from the merchant register, based on the unique identifier.

17. A system according to claim 15, wherein the at least one settlement server memory and the settlement server computer program code is further configured to, with the at least one settlement processor, cause the settlement server to send a request comprising the unique identifier to the transaction management server to obtain transaction details to effect settlement of the transaction note.

18. A system according to claim 17, wherein the at least one transaction server memory and the transaction server computer program code is further configured to, with the at least one transaction server processor, cause the transaction management server to send the transaction details from the transaction management server to the settlement server in response to receipt of the request to obtain transaction details.

19. A system according to claim 15, wherein the transaction management server comprises a cloud server.

20. A system according to claim 15, wherein the settlement management server comprises a cloud server.
